(19) United States
(12) Patent Application Publication
(10) Pub. No.: US 2018/0165162 A1
(43) Pub. Date: Jun. 14, 2018

(54) RESTORE POINT CALENDAR

(71) Applicant: International Business Machines Corporation, Armonk, NY (US)

(72) Inventors: Sean P. Cox, San Francisco, CA (US); David G. Derk, Gibsonia, PA (US); Kevin L. Gibble, Tucson, AZ (US); Andres F. Holguin, Pembroke Pines, FL (US); James P. Smith, Redwood City, CA (US); Steven V. Voyk, Austin, TX (US); Martine B. Wedlake, Hillsboro, OR (US); Jean X. Yu, Austin, TX (US)

(73) Assignee: International Business Machines Corporation, Armonk, NY (US)

(21) Appl. No.: 15/373,385

(22) Filed: Dec. 8, 2016

(51) Int. Cl. G06F 11/14; G06F 3/0482

(52) U.S. Cl. CPC G06F 11/1469; G06F 2201/84; G06F 3/0482

(57) ABSTRACT

A method for presenting options associated with restoring data is disclosed. In one embodiment, such a method includes providing a calendar, such as a monthly calendar, showing multiple days. The method enables a user to select a day on the calendar. In response to the selection, the method automatically displays, together with the calendar, a list of restore points associated with the selected day. The method further enables a user to select a restore point in the list. In response to the selection, the method automatically displays, together with the calendar and list of restore points, a list of restore options associated with the selected restore point. The method further enables the user to select a restore option, associated with a data recovery method, from the list of restore options. A corresponding system and computer program product are also disclosed.

### BACKGROUND

### Field of the Invention

This invention relates to systems and methods for presenting options associated with restoring data.

### Background of the Invention

Data is increasingly one of an organization's most valuable assets. Accordingly, it is paramount that an organization protect its data, particularly its business-critical data. Statistics show that a high percentage of organizations, as high as fifty percent, are unable to recover from an event of significant data loss, regardless of whether the loss is the result of a virus, data corruption, physical disaster, software or hardware failure, human error, or the like. At the very least, significant data loss can result in lost income, missed business opportunities, and/or substantial legal liability. Accordingly, it is important that an organization implement adequate policies and procedures to prevent such losses from occurring. In many cases, an organization will protect data using a variety of strategies, such as traditional backups, remote data replication, and periodic snapshots. Each of these protection strategies has advantages and disadvantages and uses different techniques to restore lost or damaged data.

When data is lost or damaged, an administrator may have various options in terms of dates and times to restore data, which data to restore, and recovery methods used to restore data. For example, data may be restored from a traditional backup in the event data loss is the result of a software bug, hardware failure, or user error such as deletion of a file or directory. Alternatively, in some situations, data may be restored more rapidly from a snapshot (i.e., point-in-time copy). Unfortunately, options that are available are not always presented to an administrator in an intuitive, efficient, or user-friendly manner.

In view of the foregoing, what are needed are systems and methods to present options associated with restoring data in a more intuitive, efficient, and/or user-friendly manner.

### SUMMARY

The invention has been developed in response to the present state of the art and, in particular, in response to the problems and needs in the art that have not yet been fully solved by currently available systems and methods. Accordingly, systems and methods are disclosed to more effectively present options associated with restoring data. The features and advantages of the invention will become more fully apparent from the following description and appended claims, or may be learned by practice of the invention as set forth hereinafter.

Consistent with the foregoing, a method for presenting options associated with restoring data is disclosed. In one embodiment, such a method includes providing a calendar, such as a monthly calendar, showing multiple days. The method enables a user to select a day on the calendar. In response to the selection, the method automatically displays, together with the calendar, a list of restore points associated with the selected day. The method further enables a user to select a restore point in the list. In response to the selection, the method automatically displays, together with the calendar and list of restore points, a list of restore options associated with the selected restore point. The method further enables the user to select a restore option, associated with a data recovery method, from the list of restore options.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing an example of a computing system in which a system and method in accordance with the invention may be implemented;

FIG. 2 shows a first example of a calendar, restore point list, and restore option list displayed together on a graphical user interface;

FIG. 3 shows a second example of a calendar, restore point list, and restore option list displayed together on a graphical user interface;

FIG. 4 shows a third example of a calendar, restore point list, and restore option list displayed together on a graphical user interface; and

FIG. 5 shows various modules that may be used to implement a system and method in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer-readable storage medium (or media) having computer-readable program instructions thereon for causing a processor to carry out aspects of the present invention.

The computer-readable storage medium may be a tangible device that can retain and store instructions for use by an instruction execution device. The computer-readable storage medium may be, for example, but is not limited to, an electronic storage system, a magnetic storage system, an optical storage system, an electromagnetic storage system, a semiconductor storage system, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage system via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer-readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus, or other device to produce a computer-implemented process, such that the instructions which execute on the computer, other programmable apparatus, or other device implement the functions/acts specified in the flowchart and/or block diagram block or blocks.

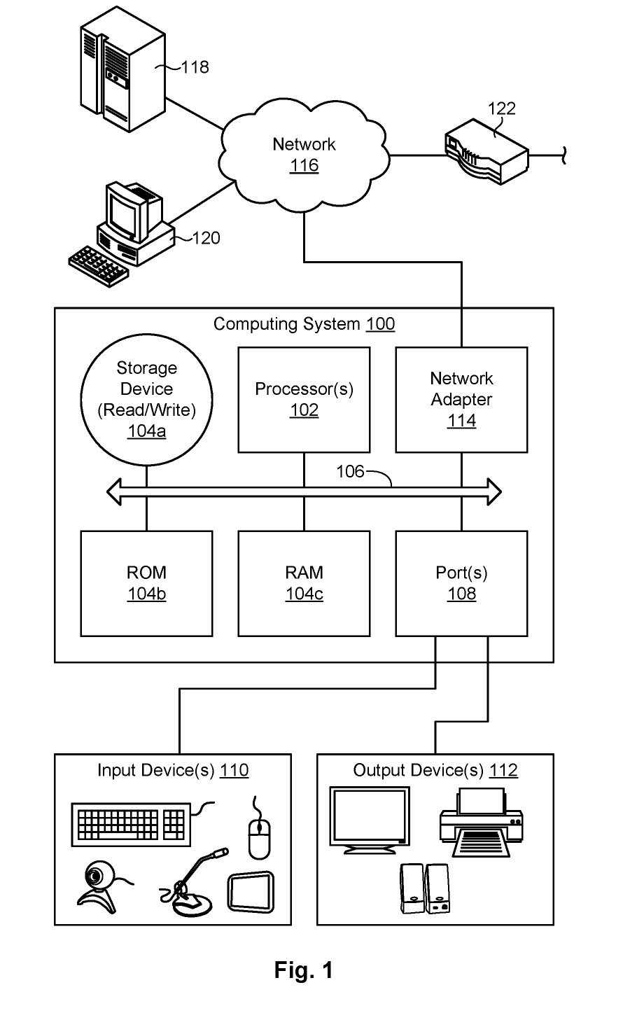

Referring to FIG. 1, one example of a computing system 100 is illustrated. The computing system 100 is presented to show one example of an environment where a system and method in accordance with the invention may be implemented. The computing system 100 may be embodied as a mobile device 100 such as a smart phone or tablet, a desktop computer, a workstation, a server, or the like. The computing system 100 is presented only by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a wired or wireless network adapter 114 to connect the computing system 100 to a network 116, such as a LAN, WAN, or the Internet. Such a network 116 may enable the computing system 100 to connect to one or more servers 118, workstations 120, personal computers 120, mobile computing devices, or other devices. The network 116 may also enable the computing system 100 to connect to another network by way of a router 122 or other device 122. Such a router 122 may allow the computing system 100 to communicate with servers, workstations, personal computers, or other devices located on different networks.

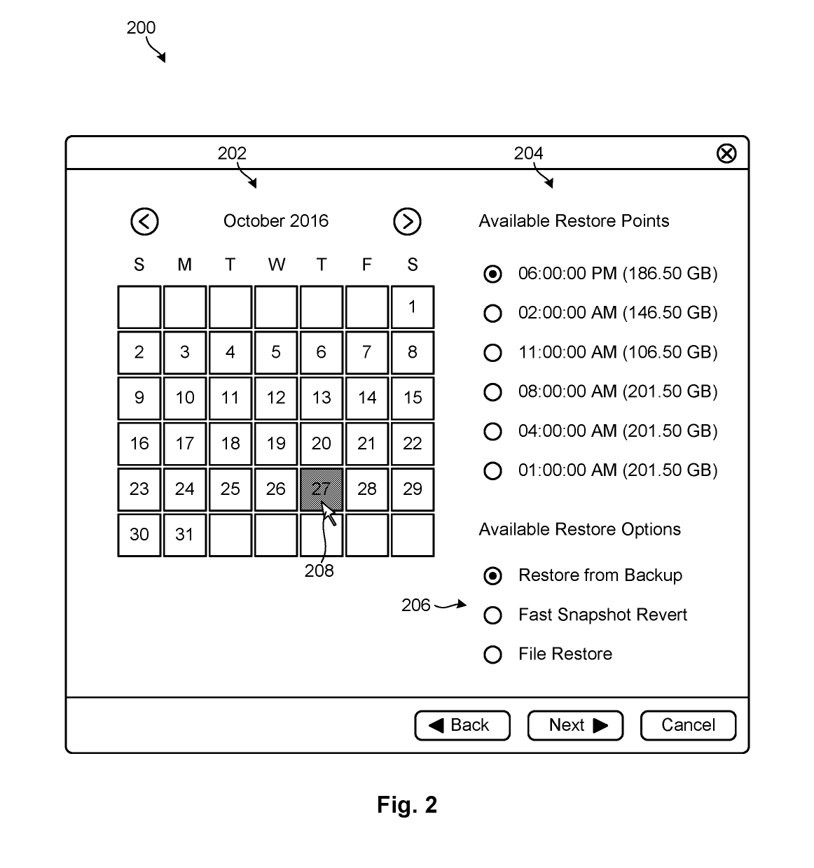

Referring to FIG. 2, as previously mentioned, when data is lost or damaged, an administrator may have various options in terms of dates and times to restore data, which data to restore, and recovery methods used to restore data. For example, data may need to be restored from a traditional backup in the event data loss is the result of a software bug, hardware failure, or user error such as deletion of a file or directory. Alternatively, in some situations, data may be restored more rapidly from a snapshot (i.e., point-in-time copy). Unfortunately, options that are available to an administrator to restore data are not always presented in an intuitive, efficient, or user-friendly manner.

FIG. 2 shows one embodiment of a graphical user interface 200, in this example a window 200, that may be presented to a user. As can be observed, the graphical user interface 200 includes three primary components: a calendar 202, restore point list 204, and restore options list 206. The instant inventors have found that simultaneously displaying these three components on the same graphical user interface 200 provides an intuitive, efficient, and user-friendly interface for restoring data, such as files, volumes, and data associated with virtual machines.

In the illustrated embodiment, the calendar 202 is a monthly calendar 202 that displays days in a grid-like pattern. A user may select a day of the month by clicking the element (e.g., box, etc.) associated with the day with a mouse pointer 208 (or possibly a finger or stylus if using other types of devices). The element representing the day may change color or become highlighted when selected, as shown in FIG. 2. Selecting a day may cause a list 204 of restore points to be displayed for the day. In the illustrated example, a list 204 of six restore points is displayed for October 27. Each restore point may have a time and size associated therewith. The time may indicate the time to which data will be restored or rolled back when using the restore point. Similarly, the size may indicate how large the restored data will be when using the restore point, or an amount of backend storage utilized in association with the restore point. In the illustrated embodiment, a restore point may be selected by selecting a corresponding radio button, although other methods of selection may also be used.

Selecting a restore point may cause a list 206 of associated restore options to be displayed for the restore point. In the illustrated embodiment, the selected restore point has three restore options associated therewith, namely “restore from backup,” “fast snapshot revert,” and “file restore.” The “restore from backup” option may enable data to be restored from conventional backup data, such as offsite or remote backup data. The “fast snapshot revert” option may enable data to be quickly restored from a snapshot or point-in-time copy. This option may not be available or selectable in response to hardware failures such as storage media failures.

The “file restore” option may enable data to be restored at the file level or at other lower levels of granularity, as opposed to having to restore an entire volume. In certain embodiments, the “file restore” option may be enabled or implemented by indexing the metadata of files or other data elements within a volume, and then making this index available when restoring data. For example, an administrator may mount a volume and explore the volume or search for specific files or data elements within the volume when deciding what data to restore. These files or data elements could then be restored without having to restore the entire volume. This may significantly reduce an amount of time required to restore data.

The restore options shown in FIG. 2 are presented by way of example and are not intended to represent an exhaustive list of possible restore options. Other restore options are possible and within the scope of the invention. It should also be recognized that each restore point may have a different set of possible restore options associated therewith. This could be implemented by changing the restore option list 206 for each selected restore point or simply making some restore options non-selectable (such as by graying out, etc.) for certain restore points.

In certain embodiments, mousing over a day in the calendar 202 may cause the restore point list 204 associated with the day to be temporarily displayed. This may enable an administrator to quickly peruse restore points associated with each day without actually selecting a day. Similarly, mousing over a restore point in the restore point list 204 may, in certain embodiments, cause restore options associated with the restore point to be temporarily displayed. This may enable an administrator to quickly browse restore options associated with each restore point without actually selecting a restore point.

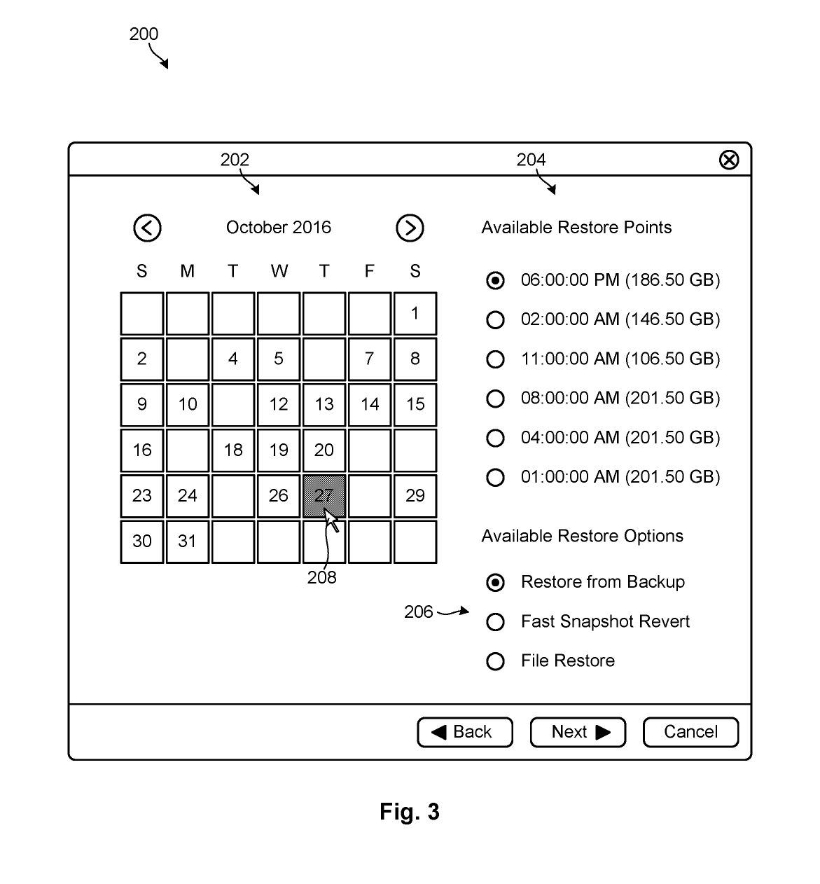

Referring to FIG. 3, in certain embodiments, other features may be added to the graphical user interface 200 and more particularly the calendar 202 to increase or enhance the amount and type of information that is provided to an administrator. For example, the calendar 202 may convey information regarding the existence of restore points associated with particular days of the month. In the illustrated embodiment, numbers are provided for days that have at least one restore point associated therewith, while number are omitted for days that have no restore points associated therewith. This information could also be conveyed with colors, shades, bolding, highlighting, or other types of indicators or omissions of indicators. This information may provide an administrator with a bird's-eye view of restore point coverage for a month or other time period comprising multiple days. This, in turn, may enable the administrator to adjust data protection policies to improve or adjust how and when data is protected.

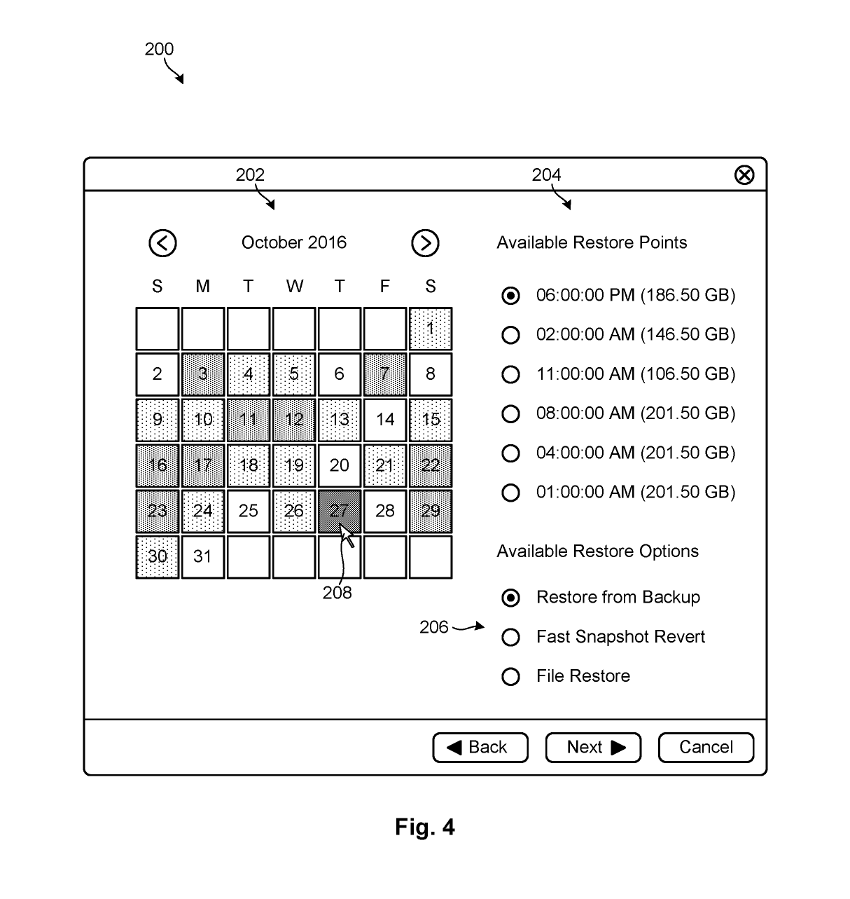

Referring to FIG. 4, the concepts discussed in association with FIG. 3 may in certain embodiments be taken a step further to indicate the density of restore points associated with particular days on the calendar 202. For example, different colors or shades may indicate different numbers of restore points associated with the days. As an example, a first shade may indicate that a day has from one to three restore points associated therewith, while a darker shade may indicate that the day has more than three restore points associated therewith. No shade may indicate that the day has no restore point associated therewith. Like the previous example, this information could also be conveyed with colors, bolding, highlighting, or other types of indicators or omissions of indicators. Restore point density information may provide an administrator, at quick glance, additional information regarding where restore points are concentrated on the calendar 202, This, in turn, may enable the administrator to adjust data protection policies to improve or adjust how and when data is protected.

The concepts shown in FIGS. 3 and 4 may also be extended to show, on the calendar 202, restore options that are available for each day on the calendar 202. For example, an element (e.g., block) representing a day on the calendar 202 may show, using shades, colors, or other indicators, not only whether restore points are associated with each of the days, but also what restore options are available. For example, the presence of a number on the element may indicate whether a restore point is available for that day, and the shade of the element may indicate which restore option is associated with the restore point. If multiple restore options are associated with the restore point, multiple shades may be displayed on the element, perhaps adjacent to one another. In other cases, small indicators (e.g., icons, labels) may be displayed on the elements to indicate restore points, and the color or shade of the indicators may indicate the restore option or options associated with the indicators. These are just a few examples and are not intended be limiting. Indeed, many different embodiments are possible for displaying restore point and restore option information on the calendar 202 for each day.

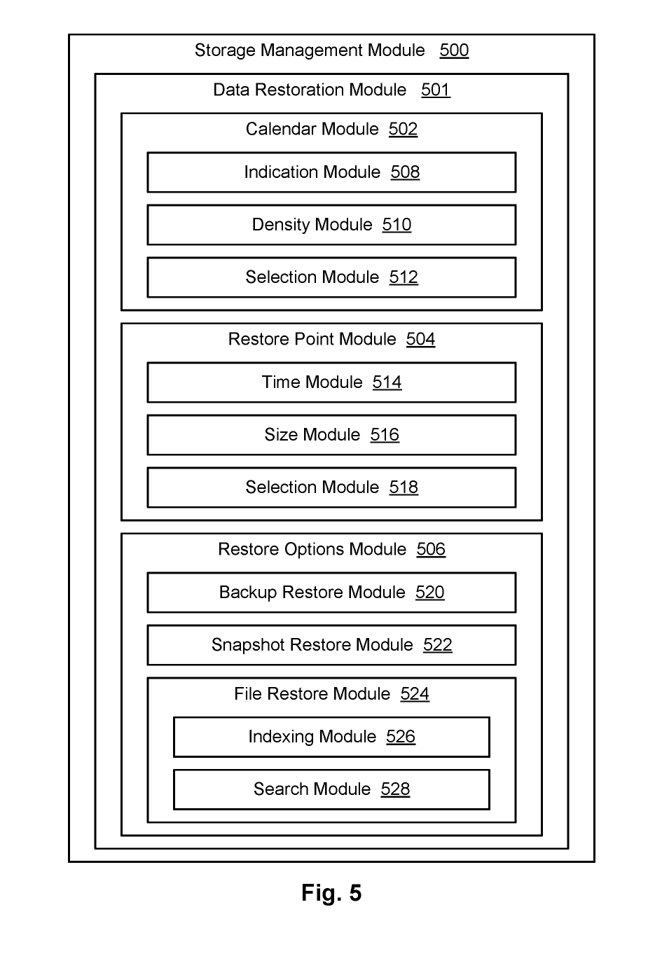

Referring to FIG. 5, in order to implement the functionality described above, a data restoration module 501 may be provided. The data restoration module 501 may be provided as part of a larger more comprehensive storage management module 500. The data restoration module 501 may include various sub-modules to provide various features and functions. These sub-modules may include one or more of a calendar module 502, restore point module 504, and restore options module 506. The data restoration module 501 and associated sub-modules may be implemented in hardware, software, firmware, or combinations thereof. The sub-modules are presented by way of example and are not intended to represent an exhaustive list of sub-modules that may be included in or associated with the data restoration module 501. The data restoration module 501 may include more or fewer sub-modules than those illustrated, or the functionality of the sub-modules may be organized differently.

The calendar module 502 may be configured to display a calendar 202, such as the monthly calendar 202 shown in FIGS. 2 through 4, in a graphical user interface 200. Where the calendar 202 is a monthly calendar 202, buttons or other controls may be provided to enable an administrator to scroll from month to month, or directly select a desired month. As shown, the calendar module 502 includes an indication module 508, density module 510, and selection module 512. The indication module 508 may indicate whether days on the calendar 202 have restore points associated therewith. The density module 510 may indicate a density of restore points associated with the days. As described above, this density may be indicated by a color, shade, highlighting, or the like. The selection module 512 may enable an administrator to select a day on the calendar 202, which may in turn invoke the restore point module 504.

When a day is selected on the calendar 202, the restore point module 504 may present a list 204 of restore points to the administrator. The restore point module 504 may include one or more of a time module 514, size module 516, and selection module 518. The time module 514 may list a time for each restore point in the list 204 and the size module 516 may list a size for each restore point in the list 204. The size may be expressed, for example, as a total size of data once it restored, or an amount of backend storage that is being utilized in association with a restore point or associated restore option (e.g., data stored on backend storage to preserve a point-in-time copy, backend storage used to store a data backup, etc.). The selection module 518 may enable an administrator to select a restore point in the list 204, which may in turn invoke the restore options module 506.

When a restore point is selected in the list 204, the restore options module 506 may present a list 206 of restore options that may be used in association with the restore point. Various sub-modules may be used to invoke various restore options when selected by an administrator. For example, a backup restore module 520 may restore data from a data backup. A snapshot restore module 522 may restore data from a snapshot. A file restore module 524 may restore data at a lower level of granularity, namely at the file level. In order to implement the file restore module 524, an indexing module 526 may index metadata associated with files in a volume, and a search module 528 may enable this index to be searched for desired files. Once a file or files are selected, the file restore module 524 may restore the file or files as opposed to the entire volume.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for presenting options associated with restoring data, the method comprising:
providing a calendar showing a plurality of days;
enabling a user to select a day from the plurality of days;
automatically displaying, together with the calendar, a first list of restore points associated with the selected day;
enabling a user to select a restore point in the first list;
automatically displaying, together with the calendar and selected restore point, a second list of restore options associated with the selected restore point; and
enabling a user to select a restore option from the second list.

2. The method of claim 1, further comprising showing, on the calendar, which days of the plurality of days have restore points associated therewith.

3. The method of claim 2, further comprising showing, on the calendar, restore point density for days that have restore points associated therewith.

4. The method of claim 3, wherein showing restore point density comprises using at least one of shade and color to show restore point density for each day.

5. The method of claim 1, further comprising showing, on the calendar, only days that have restore points associated therewith.

6. The method of claim 1, wherein the calendar is a monthly calendar.

7. The method of claim 1, further comprising simultaneously displaying the calendar, first list, and second list on the same graphical user interface.

8. A computer program product for presenting options associated with restoring data, the computer program product comprising a computer-readable storage medium having computer-usable program code embodied therein, the computer-usable program code configured to perform the following when executed by at least one processor:
provide a calendar showing a plurality of days;
enable a user to select a day from the plurality of days;
automatically display, together with the calendar, a first list of restore points associated with the selected day;
enable a user to select a restore point in the first list;
automatically display, together with the calendar and selected restore point, a second list of restore options associated with the selected restore point; and
enable a user to select a restore option from the second list.

9. The computer program product of claim 8, wherein the computer-usable program code is further configured to show, on the calendar, which days of the plurality of days have restore points associated therewith.

10. The computer program product of claim 9, wherein the computer-usable program code is further configured to show, on the calendar, restore point density for days that have restore points associated therewith.

11. The computer program product of claim 10, wherein showing restore point density comprises using at least one of shade and color to show restore point density for each day.

12. The computer program product of claim 8, wherein the computer-usable program code is further configured to show, on the calendar, only days that have restore points associated therewith.

13. The computer program product of claim 8, wherein the calendar is a monthly calendar.

14. The computer program product of claim 8, wherein the computer-usable program code is further configured to simultaneously display the calendar, first list, and second list on the same graphical user interface.

15. A system for presenting options associated with restoring data, the system comprising:
at least one processor;
at least one memory device operably coupled to the at least one processor and storing instructions for execution on the at least one processor, the instructions causing the at least one processor to:
provide a calendar showing a plurality of days;
enable a user to select a day from the plurality of days;
automatically display, together with the calendar, a first list of restore points associated with the selected day;
enable a user to select a restore point in the first list;
automatically display, together with the calendar and selected restore point, a second list of restore options associated with the selected restore point; and
enable a user to select a restore option from the second list.

16. The system of claim 15, wherein the instructions further cause the at least one processor to show, on the calendar, which days of the plurality of days have restore points associated therewith.

17. The system of claim 16, wherein the instructions further cause the at least one processor to show, on the calendar, restore point density for days that have restore points associated therewith.

18. The system of claim 17, wherein showing restore point density comprises using at least one of shade and color to show restore point density for each day.

19. The system of claim 15, wherein the calendar is a monthly calendar.

20. The system of claim 15, wherein the instructions further cause the at least one processor to simultaneously display the calendar, first list, and second list on the same graphical user interface.
